(19) United States
(12) Patent Application Publication
(10) Pub. No.: US 2003/0213922 A1
(43) Pub. Date: Nov. 20, 2003

(54) Nanolithography molecular beam machine

(75) Inventors: Robert J. Gordon, Skokie, IL (US); Tamar Seideman, Evanston, IL (US); Langchi Zhu, Oak Park, IL (US); Andreas Schroeder, Downers Grove, IL (US)

Correspondence Address: WELSH & KATZ, LTD, 120 S RIVERSIDE PLAZA, 22ND FLOOR, CHICAGO, IL, 60606, US

(73) Assignees: The Board of Trustees of the University of Illinois, University of Illinois, Chicago, IL; Steacie Institute for Molecular Science, National Research Council of Canada, Ottawa (CA)

(21) Appl. No.: 10/437,620

(22) Filed: May 14, 2003

Related U.S. Application Data
(60) Provisional application No. 60/380,793, filed on May 15, 2002.
(60) Provisional application No. 60/438,133, filed on Jan. 6, 2003.
(60) Provisional application No. 60/380,754, filed on May 15, 2002.

(51) Int. Cl. H05H 3/00

(52) U.S. Cl. 250/492.1; 250/251

(57) ABSTRACT

A method of directly writing on a surface of a substrate with neutral molecules uses a collimated beam of neutral molecules having a first direction of travel, a laser light energy field having a second direction of travel; and intersects the laser light energy field with the collimated beam of neutral molecules at a grazing angle of incidence between the first direction of travel and the second direction of travel to control the formation of features comprising the neutral molecules on the surface of the substrate.

### CROSS REFERENCE TO RELATED APPLICATIONS

This application claims the benefit of priority to U.S. Provisional Applications No. 60/380,754 filed on May 15, 2002, and U.S. Provisional Application No. 60/438,133 filed on Jan. 6, 2003.

### FEDERAL RESEARCH STATEMENT

This invention was made with government support under Grant No. DE-FG02-98ER14880 awarded by the Chemical Sciences, Geosciences and Biosciences Division of the Office of Basic Energy Sciences, Office of Science, U.S. Department of Energy. The U.S. government has certain rights in the invention.

### BACKGROUND OF THE INVENTION

This invention relates generally to nanolithography and, more particularly, to methods and apparatus for directly writing features onto surfaces with neutral molecules.

In microelectronics, the need for further miniaturization and a reduction in feature size is well known. Currently used nanoscale machining technology is limited both in feature size and in usable materials. Photolithography, the most commonly used process, involves using a light source to project a pattern onto the surface of a substrate by irradiating the surface through a mask and ion etching areas of the surface. The feature size that can be produced by photolithography is diffraction limited to typically λ/3, where λ is the wavelength of the light source. Further, ion etching causes ion sputtering which also acts a limitation on the feature size. In photolithography, the shortest wavelength used commercially today is 193 nm, which is produced by the ArF laser, whereas the shortest excimer wavelength available is 157 nm, which is produced by the F₂ laser. Thus, in laser photolithography the feature size may be limited to approximately 80 nm. Optical lithography using a multilevel and/or an inorganic resist system is able to achieve higher resolution, but the processing steps for optical lithography have not been fully realized.

Another commonly used process called electron beam lithography involves focusing of an electron beam onto the target surface. The feature size that can be produced by electron beam lithography is limited because of proximity effects. Further, electron beam lithography produces lower resist sensitivity and lower throughput. A specific type of electron beam lithography called electron beam projection lithography has attracted a great deal of interest, because of the ability to achieve high resolution over a large field with high throughput. Electron beam projection lithography is also limited because of charge proximity.

Other less commonly used lithography techniques also have limitations. For example, X-ray lithography involves irradiation of a masked surface with a bright X-ray source and offers both sub-micron resolution and high wafer throughput. However, X-ray lithography is also limited because of the difficulties of mask fabrication, and the great expense or inconvenience in accessing strong X-ray sources such as synchrotrons.

Recently, a technique for direct writing of neutral particles onto a surface has been investigated. This technique involves trapping atoms in a dipole potential produced by a standing light wave parallel to the surface. The trapped atoms are deposited onto the surface of a substrate in a set of parallel lines spaced by λ/2. Although this approach also is promising, it is limited because only atoms having a simple level structure can be used. Further, this method requires substantial transverse cooling of the atoms and suffers a poor contrast ratio. Because this method produces a set of parallel lines, it could not be used to generate complex patterns. Moreover, the λ/2 spacing of the lines precludes the generation of sub-100 nm spacing using currently available technology.

In particular, as presently understood in papers such as [1], [2], [3], molecular optics is formulated with the laser and molecular beams perpendicular to each other (i.e., with δ=90°), and experimental practice [6][7][8][9] of such theories have so far been confined to this geometry. In such studies the laser beam is pulsed in order to obtain even minimally operable intensities for impractically short periods of time.

For all of these reasons, current lithography developments and/or processes suffer from many drawbacks and are limited. Accordingly, a need exists for a nanolithography molecular beam machine to improve miniaturization and feature sizes in microelectronics.

### SUMMARY OF THE INVENTION

This invention is concerned with methods and apparatus for writing features comprising neutral molecules on a substrate.

A method for direct writing on a surface of a substrate with neutral molecules delivers a collimated beam of neutral molecules having a first direction of travel. The method also delivers a laser light energy field having a second direction of travel. The laser light energy field is intersected with the collimated beam of neutral molecules at a grazing angle of incidence between the first direction of travel and the second direction of travel to control the formation of features comprising the neutral molecules on the surface of the substrate.

Another embodiment can use any neutral atom or molecule. The atom or molecule may be chosen from, but is not limited to the following list: metal atoms, metal clusters, semiconductor atoms, semiconductor clusters, dielectric atoms, and dielectric molecules.

In an alternative embodiment, the laser energy field has a divergence in the second direction of travel, and the angle of incidence between the first direction of travel and the second direction of travel is at least about twice the divergence of the laser energy field.

In another embodiment the laser light energy field has a polarization vector and upon intersection with the laser light energy field the spatial extent of the collimated beam of neutral molecules is reduced in the direction of the polarization vector of the laser light energy field.

In another embodiment of the present invention, a circular laser focus is used to deliver the laser light energy field.

In another embodiment, the chromatic aberration of the collimated beam of neutral molecules is reduced by reducing the rotational temperature of the neutral molecules by introducing the neutral molecules as a seed gas contained in carrier gas through a nozzle via a supersonic expansion in a reduced pressure environment.

In a further embodiment, delivery of the laser light energy field further includes suppressing higher order modes of the laser light energy field.

The beam of neutral molecules can delivered as a pulsed beam of neutral molecules, while the laser light source is delivered as a pulsed laser light field, such that the pulsing of the molecular beam and the laser light field are synchronized.

In another embodiment, the beam of neutral molecules is delivered as a substantially continuous beam of neutral molecules, while the laser light energy field is delivered as a substantially continuous laser light field.

The invention also contemplates a method of producing nanostructures with controlled electrical and optical properties. Such a method provides a plurality of neutral molecules having anisotropic polarizabilities. The plurality of neutral molecules move in a direction of travel. Thereafter, a dipole force is applied to the molecules at a grazing angle of incidence relative to the direction of travel to manipulate the molecules according to influence the molecules further travel according to the molecules' anisotropic polarizabilities.

The invention also concerns an apparatus for direct writing on a surface of a substrate with neutral molecules in a vacuum chamber. The apparatus has a molecular beam source configured to deliver a collimated beam of neutral molecules into the vacuum chamber and a laser light source configurable to intersect a laser light energy field with the collimated beam of neutral molecules at a grazing angle of incidence in the vacuum chamber. The apparatus is configured such that the intense laser light can focus the collimated beam of neutral molecules onto the surface of the substrate such that molecules can form features on the surface of the substrate.

In another embodiment, the molecular beam source produces a pulsed beam of neutral molecules, and the laser light source produces a pulsed laser light field and the pulsing of the molecular beam and the laser light field are synchronized to substantially intersect the two beams.

In an alternative embodiment, the molecular beam source produces a continuous beam of neutral molecules, and the laser light source produces a continuous wave laser light field.

In a still further embodiment, the laser light source further comprises a capillary, configurable to pass the laser light energy field through the capillary before the laser light energy field intersects the beam of neutral molecules. The radius of the capillary can be selected to suppress higher order modes of the laser light energy field.

In another apparatus for direct writing on a surface of a substrate with neutral molecules, the apparatus uses a vacuum chamber. A molecular beam source is configured to deliver a substantially continuous collimated beam of neutral molecules into the vacuum chamber. The apparatus also has a laser light resonance cavity configurable to intersect a laser light energy field with the collimated beam of neutral molecules at a grazing angle of incidence in the vacuum chamber. The apparatus is used to have the intense laser light focus the collimated beam of neutral molecules onto the surface of the substrate such that molecules can form features on the surface of the substrate.

In one embodiment, the laser light resonance cavity comprises at least one thin Ytterbium-doped YAG (Yb:YAG) gain medium with a large contact area. In another embodiment a focusing element is included in the laser resonance cavity.

For convenience, the vacuum chamber further comprises Brewster-angled windows that are oriented to assure vertically polarized radiation can be used to couple the intracavity radiation into and out of the vacuum chamber.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIGS. 1a-c are schematic drawings of the focusing of a molecular beam by a laser beam, shown from three orthogonal perspectives: (a) Plane of the two beams; (b) A slice in the y-z plane, perpendicular to the direction of the laser beam. (The molecular beam intersects the laser beam from the left, but is contained in the plane of this perspective only for δ=90°.); (c) Slices in the x-y plane showing cross sections of the molecular beam before and after focusing.

FIG. 2 shows that intensity dependence of the focal coordinates in the large-R limit.

FIG. 3 shows the focal coordinates of the molecular beam as a function of incidence angle.

FIGS. 4a-b show the effect of spherical aberration on the focal width of the molecular beam. (a) Trajectories for a molecular beam of I₂ in Xe having an initial width Wᵢ=10 μm focused by a laser with ω₀=30 μm , at a peak intensity of 10⁸ W/cm² and an intersection angle of 5⁰. Both the translational and rotational temperatures are zero.

(b) Variation of the focal width with the radius of a circular Gaussian focus.

FIGS. 5a-b show the chromatic aberration produced by the translational energy distribution of the molecular beam. (a) Trajectories for a molecular beam of I₂ in a Xe carrier gas with Tₜᵣₐₙₛ=1K. The three trajectories for each value of y₀ are for speeds equal to vₘₚ+α (solid lines), vₘₚ (dashed lines), and vₘₚ−α (dotted lines), where vₘₚ is at the most probable speed. (a) Focal width as a function of the translational temperature. The other physical parameters are as in FIG. 4.

FIGS. 6a-b show chromatic aberration produced by rotational temperature. (a) Local width of the molecular beam as a function of the transverse distance for different initial rotational states. J is the total angular momentum, and M is its projection onto the field axis. Shown here are the evolution of [symbol] y [symbol] for J=0 (solid curve), J=1 (dashed), J=2 (dotted), and J=3 (dot-dashed). For J=2 and 3, the value of |M| increases from 0 to J starting from the lowest curve. For J=1 the order of the M curves is reversed. (b) The focal width, summed over all rotational states, as a function of rotational temperature. The curves are for different values of the ratio of γ=α_{//}/α [symbol] , with γ=2.12 corresponding to I₂ molecules. The calculations were performed assuming Tₜᵣₐₙₛ=0. The other physical parameters are as in FIG. 4.

FIG. 7 shows the effect of Gaussian laser transverse mode structure on the focal width. The parameter s is the fraction of the laser intensity in the higher order mode. All other physical parameters are the same as in FIG. 4.

FIG. 8 illustrates a block diagram of a nanolithography molecular beam machine in accordance with an embodiment of the invention using a laser beam directed into the machine from outside the chamber.

FIG. 9 illustrates an exemplary embodiment using a laser source external to the chamber in a collinear configuration for continuous mode operation. In this embodiment, the substrate lies outside of the laser cavity.

FIG. 10 is a schematic of a 1 kW TEM₀₀ mode Yb:YAG thin-disk laser for the apparatus of FIG. 8.

FIG. 11 illustrates an exemplary embodiment wherein the resonance chamber of a laser passes through the molecular beam to focus it on the substrate. In this embodiment, the substrate lies inside of the laser cavity.

FIG. 12 is a schematic illustrating the optics of the embodiment of FIG. 11 wherein the gain medium and a mode control capillary are located outside the vacuum chamber.

### DETAILED DESCRIPTION OF THE INVENTION

Although the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

It is to be further understood that the title of this section of the specification, namely, “Detailed Description of the Invention” relates to a requirement of the United States Patent and Trademark Office, and is not intended to, does not imply, nor should be inferred to limit the subject matter disclosed herein or the scope of the invention.

The operation of molecular optics is governed by the interaction of a spatially inhomogeneous electric field, such as a laser beam, with the polarizability tensor of molecules of interest, which may be in a molecular beam, to provide control over the molecules of interest in a way that is analogous to the way an optical lens focuses light. Just as the optics of photons can be analyzed either through classical optical geometries or more modern ray tracing techniques, the control of molecules by a laser beam can be analyzed with varying degrees of specificity or using various models. Although the present invention is explained, in part, using a particular mathematical approach, the present invention is not limited by the exemplary explanation that follows.

The field-matter interaction at nonresonant frequencies, for a linearly polarized electric field and a linear or symmetric top molecule, can be cast in the form of an induced Hamiltonians [5]

$${H}_{ind} ( r , Θ , t ) = - \frac{1}{4} {ϵ}^{2} ( r , t ) ( {α}_{//} {cos}^{2} Θ + {α}_{⊥} {sin}^{2} Θ ) , \qquad ( 1 )$$

where E(r, t)=ε(r, t) cos ωₗt is the electric field, ωₗ is the laser frequency, Θ is the angle between the polarization vector and the molecular axis, and α_{∥}and α_{⊥} are the components of the polarizability tensor parallel and perpendicular to the molecular axis, respectively. In the case of laser radiation with a circular Gaussian spatial profile,

ε(r,t)=ε₀\hat{ε}e^{-r}^{²}^{/ω}^{²}f(t), (2)

where ε₀ is the peak amplitude of the field, ω is its 1/e radius, f(t) is its temporal envelope, and \hat{ε} is a unit vector in the polarization direction. The radial gradient of the potential energy generates a force that may deflect the molecule, whereas the angular gradient induces a torque that may align the molecule along \hat{ε}. The well depth of the time-averaged radial potential may be hundreds of K deep, as compared with the μK well depths typically encountered in optical lattices used to trap atoms [10]. A rough estimate of the laser-induced well depth, V_{w}^{J|M|}, for the J=0, M=0 rotational state is V_{w}⁰⁰=15 α_{∥}I₀K, for the α_{∥}is in Å³ and I₀ is in TW/cm².

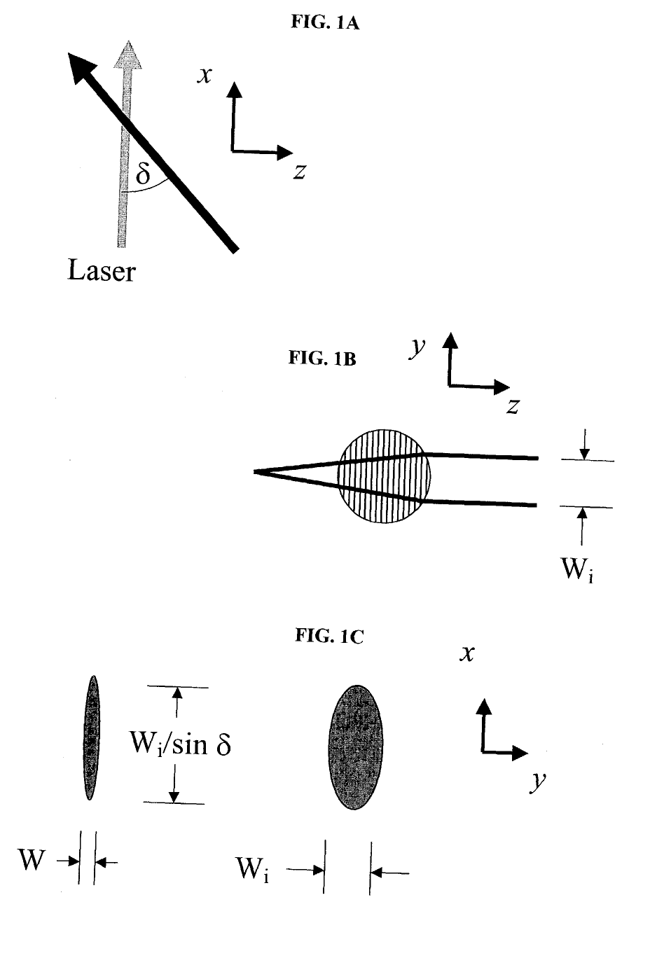

A focused laser beam behaves as a “molecular lens” that can squeeze a molecular beam into a narrow stripe. Molecular focusing is illustrated schematically in FIGS. 1a-c, and in particularly FIG. 1a, the laser propagates in the x-direction, and the molecular beam intersects it at angle, δ, in the x-z plane. The width of the beam coming from the molecular beam source is Wᵢ and the width of the focused molecular beam is W. It is readily seen by those of ordinary skill in the art that the molecular beam is compressed so as to have an elliptical cross section in the xy-plane with its major axis along the x-direction.

For later reference it is useful to summarize the qualitative features that are general to molecular lenses (independent of the molecule and field parameters). The lens parameters scale with the ratio R=E_{kin,z}|V_{w}^{J|M|} (R being synonymous with “energy ratio” for the purposes of this application.) between the component of the kinetic energy transverse to the laser beam and the laser-induced well depth [2][3]. The energy ratio characterizes the molecular lens in much the same way that the refractive index determines the properties of an optical lens. The focal distance is generally linear in R except in the small-R limit, whereas the image size is generally constant in R for large values of the energy ratio, but drops rapidly as R decreases below ˜3.

The angle of incidence is defined as the angle (δ) between the direction of the electric field and the direction of travel of the molecule. At grazing incidence, where δ <<90°, the energy ratio R∝v_{z}²/I₀ (where v_{z}=v sin δ is the z-component of the velocity and I₀ is the peak intensity) for a given electric field strength is dramatically reduced as compared to the perpendicular configuration. Equivalently, for a particular value of R required to achieve a desired focal distance, the requisite laser intensity is drastically reduced. This reduction in the intensity opens the opportunity of employing continuous-wave (cw) laser technology to focus molecular beams with presently available technology. The use of a cw laser would increase the write rate by many orders of magnitude as compared to a low-duty-cycle pulsed source, because pulsed lasers provide extremely short light pulses separated by much longer periods without light.

One advantage that arises from using a cw radiation source is that it substantially reduces or eliminates the problem of background molecules accumulating on the surface when the laser is off. In theory unwanted collisions with the surface may be suppressed also with a pulsed source, either by employing molecular and laser pulses of comparable duration or by splitting the laser into several components, so that one serves to deflect and another to focus the molecular beam. In practice, however, both routes are difficult to implement, and in any event, even if perfectly implemented, would still provide orders of magnitude fewer molecules focused by the laser.

While the present invention can be understood by the particular embodiments discussed herein, an understanding of some methods of calculation will allow those of ordinary skill in the art to practice the present invention in ways not specifically exemplified. The semi-classical methods developed in [2] can be used to calculate the trajectories of a collimated molecular beam interacting with a focused laser beam. Following adiabatic separation of the center-of-mass from the internal modes, the rotational problem is solved quantum mechanically by diagonalizing the complete Hamiltonian at fixed values of the laser field,

[Hᵣₒₜ+H_{ind}(ε)]|J M;ε [symbol] =E^{J|M|}(ε)|JM;ε [symbol] . (3)

Here Hᵣₒₜ is the free rotor Hamiltonian and

$${H}_{ind} = - \frac{1}{4} {ϵ}^{2} \{ {α}_{⊥} + ( {α}_{//} - {α}_{⊥} ) {cos}^{2} Θ \}$$

is the induced Hamiltonian of Eq. (1). The eigenstates |J M;ε [symbol] are expanded in a basis set of field-free rotor states with ε-dependent expansion coefficients, determined by solving the eigenvalue problem (3). The eigenvalues E^{J|M|}(ε) serve as adiabatic potentials for propagation of the center-of-mass motion. Taking into account the divergence of the laser beam, the amplitude of an elliptical Gaussian field with a wavelength λ and a TEM₀₀ mode is given by [11]:

$$\begin{matrix}\begin{matrix}ϵ ( x , y , z ) = {{ϵ}_{0} ( \frac{{ω}_{0 y} {ω}_{0 z}}{{ω}_{y} ( x ) {ω}_{z} ( x )} )}^{1 / 2} {ⅇ}^{- \{ {y}^{2} / {ω}_{y}^{2} ( x ) + {z}^{2} / {ω}_{z}^{2} ( x ) \}} , \\ where\end{matrix} & ( 4 ) \\ \begin{matrix}{ω}_{y}^{2} = {ω}_{0 y}^{2} + {θ}_{y}^{2} {x}^{2} \\ {ω}_{z}^{2} = {ω}_{0 z}^{2} + {θ}_{z}^{2} {x}^{2}\end{matrix} & ( 5 )\end{matrix}$$

and the divergence angles are given by

$${θ}_{y ( z )} = \frac{λ}{π {ω}_{0 y ( 0 z )}} . \qquad ( 6 )$$

The origin of the coordinate system can be taken to be the focal point of the field, as is done in FIG. 1.

Having computed quantum mechanically the effective potentials for the center-of-mass motion subject to the inhomogeneous electric field, we proceed to describe the corresponding dynamics by numerical integration of Hamilton's equations of motion [2][3],

$$\begin{matrix}\begin{matrix}\dot{x} = \frac{{p}_{x}}{m} , & {\dot{p}}_{x} = - \frac{\partial {E}^{{J}_{i} , \vert M \vert} [ ϵ ( x , y , z ) ]}{\partial x}\end{matrix} & ( 7 a ) \\ \begin{matrix}\dot{y} = \frac{{p}_{y}}{m} , & {\dot{p}}_{y} = - \frac{\partial {E}^{{J}_{i} , \vert M \vert} [ ϵ ( x , y , z ) ]}{\partial y}\end{matrix} & ( 7 b ) \\ \begin{matrix}\dot{z} = \frac{{p}_{y}}{m} , & {\dot{p}}_{z} = - \frac{\partial {E}^{{J}_{i} , \vert M \vert} [ ϵ ( x , y , z ) ]}{\partial z}\end{matrix} & ( 7 c )\end{matrix}$$

The initial coordinates, x₀, y₀, and z₀, can be selected as follows. The molecular beam can be assumed to have a non-diverging square cross section of width Wᵢ. n_{y} values of y₀ are selected uniformly between the limits—Wᵢ/2 and Wᵢ/2. The initial values of x and z are given by

x₀=rₛcos δ+ρsin δ (8)

z₀=rₛsin δ+ρcos δ,

where the “shell” radius rₛ is the distance from the center of the cross section of the molecular beam to the focal point of the laser, and ρ is the distance along a line perpendicular to the line of centers in the xz-plane. The value of rₛ is chosen large enough that a further increase in the shell radius does not affect the focal properties of the lens; ρ is selected uniformly between—Wᵢ/2 and Wᵢ/2.

The speed of the molecules can be modeled as having a supersonic Maxwellian distribution for a seed gas of mass m mixed with a carrier gas of mass m_{c} with translational temperature Tₜᵣₐₙₛ. For a highly dilute gas with no velocity slippage, the speed distribution function of the seed gas is given by [12]

$$g ( v ) = ( 1 / {q}_{trans} ) {v}^{2} {ⅇ}^{- {( \frac{v - {v}_{f}}{α} )}^{2}} , \qquad ( 9 )$$

where qₜᵣₐₙₛ is a normalization constant, α=(2kTₜᵣₐₙₛ/m)^{1/2} is the most-probable speed of the seed gas in the moving frame, and the flow speed is given by

$${v}_{f} = {{v}_{∞} ( 1 - \frac{T}{{T}_{0}} )}^{1 / 2} . \qquad ( 10 )$$

The speed of the carrier gas at infinite Mach number is given by

$${v}_{∞} = {( \frac{γ}{γ - 1} )}^{1 / 2} {α}_{0 c} , \qquad ( 11 )$$

where γ is the heat capacity ratio, T₀ is the stagnation temperature, and α_{0c}=(2kT₀/m_{c})^{1/2}. For an arbitrary incidence angle, the initial velocity components are given by

v₀ₓ=v cos δ,

v_{0y}=0,

v_{oz}=v sin δ. (12)

For most applications, the properties of the molecular lens that are of greatest interest are the width, W, of the molecular beam at the focal waist (i.e., the image size of the molecular lens) and the coordinates of the focal waist, x_{f} and z_{f} (See FIG. 1 of [3] for definitions of the lens parameters.) We determine the former by evaluating y(t) as a function of z(t), averaged over all initial conditions. This quantity is given by

$$⟨ y ( z ) ⟩ = \frac{1}{{n}_{y} {n}_{ρ}} {\sum }_{J}^{} {\sum }_{\vert M \vert = 0}^{J} {\sum }_{i = 1}^{{n}_{y}} {\sum }_{j = 1}^{{n}_{p}} {\sum }_{k} g ( {v}_{k} ; {T}_{trans} ) Δ {vP}_{{J}_{i} , \vert M \vert} y ( t ; {y}_{0 , i} , {ρ}_{j} ) , \qquad ( 13 )$$

where Δv is the spacing of grid points in the speed distribution, and P_{J}_{ᵢ}_{,|M|} is the Boltzmann rotational population. The focal width, W, can be computed as the minimum of [symbol] y(z(t)) [symbol] , which occurs at t=t_{f}, and the focal coordinates are the resulting values of x(t_{f}) and z(t_{f}).

Molecules with different initial conditions, such as direction, speed and rotational temperature, intersect the xz plane at different locations, resulting in a non-zero width of the focused structure. The properties of the molecular and laser beams will determine the location of the molecular beam waist, and applying the present invention to a particular circumstance is aided an understanding of the conditions that control the focal width, and the focal distance.

Generally, the regime of interest to the present work will be the large-R limit, where the focal distance is linear in R and the width parameter is R-independent [3]. In this limit, the location of the focus of the molecular lens is determined by the intensity of the electromagnetic field and the velocity of the molecules, and the width is determined by spherical and chromatic aberrations.

A method for conducting calculations can be understood by using I₂ as a prototypical molecule, with α_{∥}=17 Å³ and α_{⊥}=8 Å³, and Xe as the carrier gas with T₀=300 K. The initial width of the molecular beam can be set at Wᵢ=10 μm with n_{y}=40, and the electric field radius can be set at 30 μm. Averaging over ρ does not affect the focal parameters significantly, and a value of n_{ρ}=1 can be used.

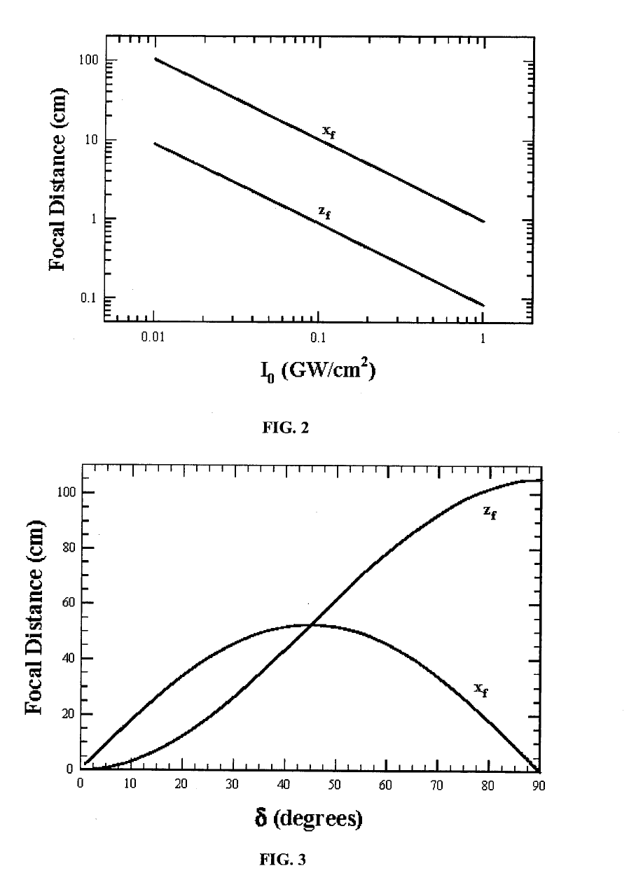

The quantities that are most important in determining the location of the focus of a molecular beam are the laser intensity and spot size, the molecular speed, and the incidence angle. FIG. 2, showing energy ratios ranging from about 43-4,300, confirms that for large R both x_{f} and z_{f} vary inversely with laser intensity [3]. Accordingly, the focal coordinates vary linearly with the square of the mean velocity, and hence, for a fixed stagnation temperature, inversely with the mass of the carrier gas. The focal coordinates for a given intensity depend on the lens curvature, increasing linearly with ω(x) for a circular Gaussian beam. (The properties of a molecular lens based on an elliptical optical focus are discussed later).

The dependence of x_{f} and z_{f} on the intersection angle of the beams is shown in FIG. 3. FIG. 3 shows that z_{f} decreases with δ, falling to zero at grazing incidence. This is expected because v_{z}, the component of the velocity transverse to the laser beam, decreases with δ. Also, as expected, x_{f} initially increases with angle, tracking the corresponding increase of vₓ. FIG. 3 also shows that x_{f} reaches a maximum at 45⁰ and decreases monotonically at larger angles.

Calculations of individual trajectories can help to understand the physical basis for this behavior. As a molecule traverses the laser beam it feels a time-dependent force. As v_{z} decreases, the magnitude of the associated impulse increases, resulting in smaller values for both x_{f} and z_{f}. The maximum in x_{f} reflects the competition between increasing transverse velocity and increasing impulse. This property explains why it is practical to use a continuous laser for lithography.

Spherical and chromatic aberrations affect the focal width that can be achieved from a particular set of circumstances. A set of calculations in which δ=5⁰ and I₀=10⁸ W/cm² can be instructive, but other values of these parameters yield essentially the same values of W in the large R-regime.

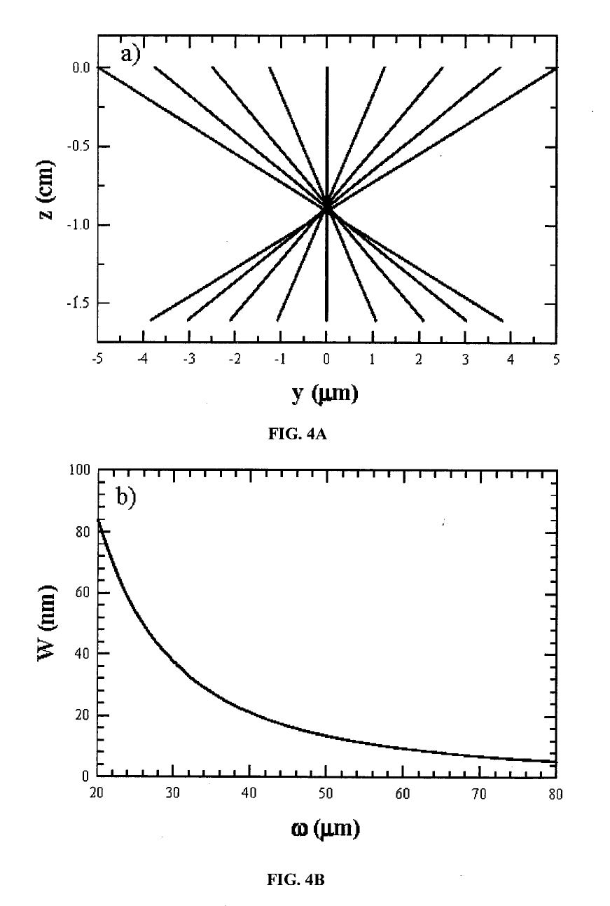

FIG. 4a shows a set of trajectories for a mono-energetic beam of I₁₂ molecules (with Tₜᵣₐₙₛ=Tᵣₒₜ=0) and a circular laser focus (ω₀=ω_{0y}=ω_{0z}=30 μm). The width of the molecular focus is caused by spherical aberration of the electromagnetic lens. FIG. 4b shows that this effect may be remedied by increasing ω₀, so that the molecular beam samples only the harmonic part of the field, with W dropping to 5 nm for ω₀=80 μm. This effect has a simple origin that was noted previously [3]. Spherical aberration can arise, as in this case, from the anharmonic shape of the potential that governs the trajectories. For a fixed molecular beam diameter, the molecules feel an increasingly harmonic force field as the spot size of the laser in the direction transverse to the plane of the molecular and laser beams (see FIG. 4b) is increased.

In the small R-regime, the use of an elliptical focus can be advantageous, because it reduces the laser power required for a constant intensity, with the additional benefit of increasing the focal distance. Calculations with an elliptical focus in the large R-limit show that, as expected, the focal width for a constant intensity depends only on ω_{y}. For an elliptical beam with ω_{z}<ω_{y}, the laser power required to produce a particular focal width decreases with ω_{z}. The calculations also show, however, that the focal distance for an elliptical beam is greater than for a circular beam with the same ω_{y}. In the large-R regime, ellipticity presents no advantage, because a greater focal distance is undesirable. In that case the higher intensity required to offset the increased focal distance cancels the savings in laser power that might otherwise have been achieved.

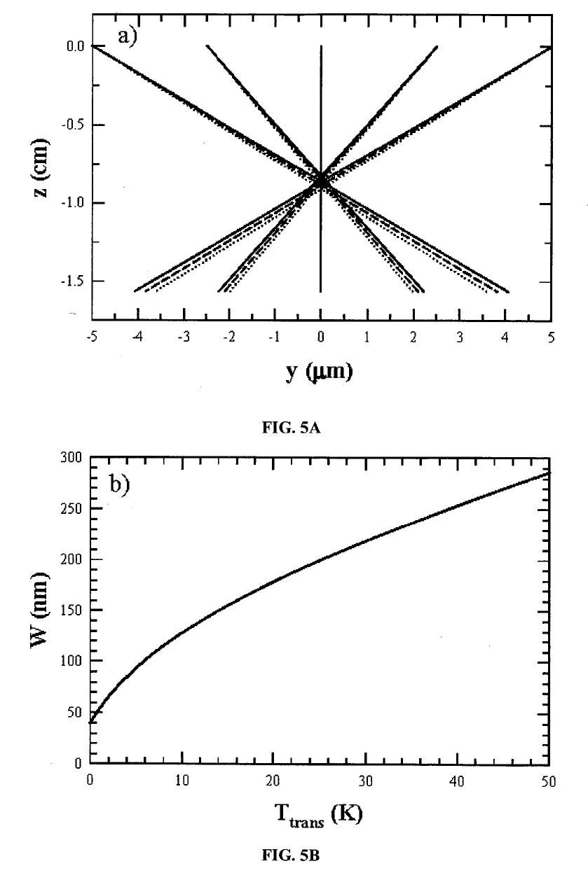

One source of chromatic aberration is the spread in initial speed of the molecular beam. Molecules with larger values of R are deflected less during their passage through the laser beam and, therefore, come to a focus at larger distances (see FIG. 5a). Consequently, the ensemble averaged image size is larger than for monochromatic trajectories. Generally, [symbol] y [symbol] increases with Tₜᵣₐₙₛ, as shown in FIG. 5b. For the case of iodine molecules we find at a translational temperature Tₜᵣₐₙₛ=1 K (which is readily achieved in a supersonic molecular beam) an image size of 54 nm, as compared to the monochromatic value of 40 nm.

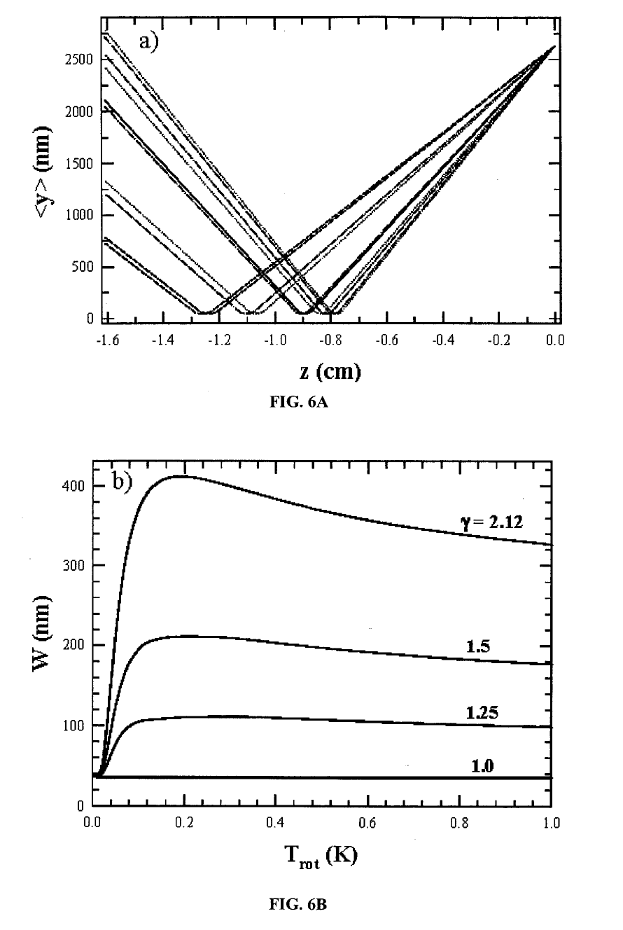

A second source of chromatic aberration is the rotational temperature of the molecular beam. The force felt by a diatomic molecule depends on the direction of the angular momentum vector, \vec{J}. If the molecule rotates in a plane perpendicular to \vec{J} (i.e., if |M|=J), it feels a smaller force than if it rotates in a plane containing \vec{J} (i.e., M=0). As shown in FIG. 6a, the focal distance is very sensitive to J and |M|, so that, although each rotational state comes to a sharp focus, the sum of over all J, M states results in a considerably broadened beam waist. The dependence of W on Tᵣₒₜ is shown in FIG. 6b. The maximum near 0.2 K occurs because J=0 and J=1 differ the most in their focal distances, and at this temperature these states have approximately equal populations. At higher Tᵣₒₜ the focal points are distributed over many more states, and the focal width slowly declines with temperature.

The effect of rotational alignment depends on the anisotropy of the polarizability. To study this dependence we artificially varied the ratio of polarizability components, γ=α_{∥}/α_{⊥}, which for I₂ has a value of 2.12. FIG. 6b shows that, as expected, W decreases with γ, and for spherically symmetric molecules it is independent of Tᵣₒₜ.

Above, a TEM₀₀ Gaussian model was used. The focusing properties of a molecular lens can be very sensitive to the transverse mode structure of the laser beam. In particular, the presence of a node in the center of the beam can have a large effect. To understand how variations in the transverse structure of the laser beam can affect results, in accordance with reference [11], those of ordinary skill can consider the electric field for a circular Gaussian beam with a TEMₘₙ mode given by

$${E}_{mn} = {E}_{0 , mn} \frac{{ω}_{0}}{ω ( x )} {H}_{m} ( \sqrt{2} \frac{y}{ω ( x )} ) {H}_{n} ( \sqrt{2} \frac{z}{ω ( x )} ) exp ( - \frac{{y}^{2} + {z}^{2}}{{ω}^{2} ( x )} + i {α}_{0} + i ( m + n ) η ( x ) ) , \qquad ( 14 )$$

where Hⱼ is a Hermite polynomial of order j, E_{0,mn} is the amplitude of the field, α₀ is the spatially dependent phase of the TEM₀₀ mode, and

$$η ( x ) = {cos}^{- 1} ( \frac{{ω}_{0}}{ω ( x )} ) . \qquad ( 15 )$$

In order to evaluate the effects of individual laser modes on the properties of a molecular lens, W can be calculated for a field consisting of a superposition of TEM₀₀ and the mode of interest,

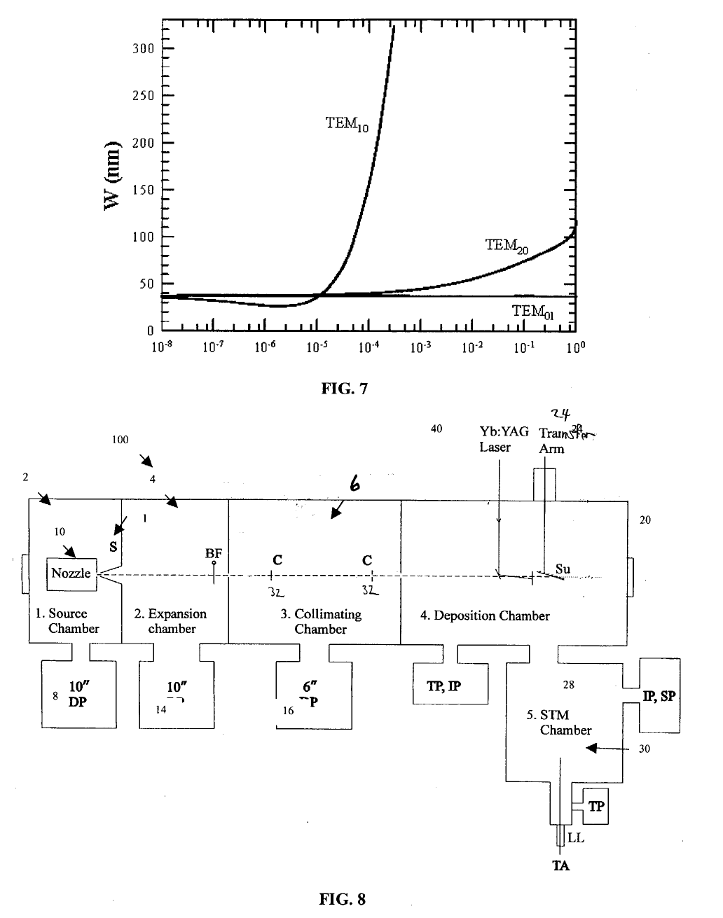

E=\sqrt{1−s}E₀₀+\sqrt{s}Eₘₙ, (16)

where s is the fractional intensity in the higher order mode. The results for TEM₀₁, TEM₁₀, and TEM₂₀ are shown in FIG. 7 as a function of s. Not surprisingly, the TEM₀₁ mode, which is symmetric with respect to the z-axis, has no effect on the focal distance just as W does not depend on ω_{z} for an elliptical TEM₀₀ mode). The TEM₁₀ mode, on the other hand, has a very strong effect. For small values of s, the extended intensity along the y-axis actually improves the focusing, with the bimodal field acting like an achromatic lens. For intensity ratios >10⁻⁵, however, the central node strongly defocuses the molecular beam. The TEM₂₀ mode, which has a maximum at y=0, has a much smaller defocusing effect even for s=1.

Even a small intensity in some of the higher order modes can have a deleterious effect. In one embodiment the amplitudes of these modes are suppressed by spatial filtering. However, in some applications it is possible that a small residual contribution from higher order modes could be troublesome. Accordingly, another embodiment applies an efficient way of suppressing the unwanted modes by passing the laser beam through a capillary, producing an electromagnetic field having the form of a truncated Bessel function (the fundamental EHₘₙ of the guide [13]),

$$\begin{matrix}{E}_{b} = {E}_{0 , b} {J}_{0} ( {ρ}_{0} \frac{r}{a} ) , for r \leq a & ( 17 \text{a} ) \\ = 0 for r > a , & ( 17 \text{b} )\end{matrix}$$

where α is the radius of the capillary, r=(y²+z²)^{1/2}, and ρ₀=2.4048 is the first zero of the zero-order Bessel function, J₀. (In these calculations the divergence of the laser beam can sometimes be ignored. The justification for this simplification is that, in this focusing regime, divergence has no measurable effect on the focusing properties of a Gaussian beam.)

The truncated field has superior focusing properties to the TEM₀₀ Gaussian field. Choosing α=ω₀ and E_{0,b}=E_{0,00}, with equal laser intensity, the Bessel beam produces a slightly larger focal width (45 vs 38 nm at α=30 μm and I₀=1×10⁸ W/cm²) at a slightly shorter focal distance (x_{f}=8.4 cm and z_{f}=0.73 cm vs. 9.2 and 0.81 cm at δ=5⁰). However, increasing α to 40.86 μm, so that the laser power is the same for both beams, reduces W to 25 nm and increases the focal distances to 11.2 and 0.98 cm. One property of the Bessel field, however, is that its decomposition into transverse resonator modes requires cylindrically symmetric Laguerre-Gaussian modes, which do not defocus the molecular beam.

FIG. 8 depicts a block diagram of an exemplary embodiment of a nanolithography molecular beam machine 100 embodying the principles discussed above. The nanolithography molecular beam machine 100 includes a highly-collimated, differentially-pumped molecular beam source 10 having an ultra-high vacuum (UHV) target deposition chamber 20, including a load-lock for inserting and removing samples, a transfer arm 24, a scanning tunneling microscope (STM) 30, and an intense source of infrared laser radiation 40. In an alternative embodiment of this machine, a scanning tunneling microscope (STM) is inserted between the target chamber and the load lock to enable in situ measurement of features deposited on the substrate.

As used herein, intense laser field or beam means a field beam with intensity in excess of approximately 2×10⁷ W/cm² when operated in continuous mode and in excess of approximately 2×10¹¹ W/cm² when operated in pulsed mode. When operated in continuous mode, the laser produces in excess of 1 KW intracavity and 100 W extracavity. In an exemplary embodiment, the nanolithography molecular beam machine 100 operates in a continuous mode, where continuous mode is defined as operating substantially continuously in time. In an alternative embodiment, the nanolithography molecular beam machine 100 may also operate in a pulsed mode, in which the laser provides light in generally distinct pulses.

In an exemplary embodiment, a source chamber 2, an expansion chamber 4, and a collimating chamber 6 prepare the molecular beam source 10 to deliver an intense, internally cold, and highly collimated stream of neutral molecules. The chamber can be made of any of the materials suitable for ultrahigh vacuum chambers, including, but not limited to type 304 stainless steel. In accordance with present usage, the term ultrahigh vacuum can mean pressures less than 2×10⁻¹⁰ Torr.

In an exemplary embodiment, the molecular beam source can have the following parameters:

a flux of approximately 10¹⁷⁻10¹⁹ molecules/ster/s

rotational temperature of the molecules (Tᵣₒₜ)≦1 K

a divergence of approximately 10 to 100 μrad

As used herein, an intense molecular beam source means a molecular beam source with a flux range between 10¹⁷ and 10¹⁹ molecules/ster/s.

In operation, a continuous supersonic beam may be generated by expanding a seeded gas mixture through a nozzle of approximately 1 mm in diameter. Source chamber 2 may be served by a first pump 8. The first pump 8 functions to exhaust the vacuum chamber, and can be of any type of pump known to those of ordinary skill in the art to perform that function including, but not limited to, diffusion pumps, turbomolecular pumps, and cryogenic pumps. In an exemplary embodiment, the first pump 8 may be a diffusion pump have a 10 in. diameter, have a pumping speed of 4, 000 1/s and a throughput of 7.5 Torr-1/s.

A skimmer 12 penetrating the Mach disk of the molecular beam extracts the central portion of the beam and delivers the beam to the expansion chamber 4. In an exemplary embodiment, the expansion chamber 4 is exhausted by a 10 in. cryo-cooled diffusion pump 14, which reaches an operating pressure of 10⁻⁴ to 10⁻⁵ Torr.

An additional source of chromatic aberration, not mentioned above, is the distribution in transverse velocity produced by the variation of the intersection angle. The variation in intersection angle may be reduced to a negligible amount by introducing a set of collimating slits 32 (present in the schematic of FIG. 8 as “C”) in the collimating chamber 6 before the interaction region. For a pair of slits of width b separated by a distance l, the geometric (parallax) contribution to the spread in v_{z} is

$$δ {v}_{z} = ( \frac{b}{l} ) v .$$

For I₂ in Xe with Tₜᵣₐₙₛ=1 K, the condition δv_{z}=0.01α is satisfied with b=100 μm and l=0.4 m. These slits are mounted in the collimating chamber 6 shown in FIG. 8. This chamber is exhausted by a 6″ cryo-cooled diffusion pump 16 which can reduce the pressure to about 10⁻⁷ Torr.

Monitoring the flow rate of particles in the molecular beam can be used to estimate the rate at which layers are written on the substrate. The number of particles hitting the target surface per unit time is given approximately by F ΦΩ, where is the Φ is the total initial particle flux, F is the mole fraction the seed gas, and Ω is the solid angle of the final aperture. The write rate is then

Γ=ΦΩσFPₛ/A, (18)

where A is the feature area, σ is the cross section of the particle, and Pₛ is its sticking probability. For Φ=10¹⁹ ster⁻¹ s⁻¹, F=1% and Pₛ=10%, with a 10 μm diameter collimating aperture located at a distance of 1 m from the beam source, a feature size of 50 nm×100 μm, and σ=1 nm², the write rate is 1.1 monolayer per minute.

The laser power required to focus the molecular beam depends on the focal distance, which scales as m/m_{c}α_{∥}I₀, and the desired focal width. Generally, the beam machine 100 will operate with an upper bound of 10 cm for the focal distances and 50 nm for the focal width. Using I₂ in Xe for the purposes of illustration, and ignoring the effect of rotational temperature (which is absent for atoms and isotropic molecules), those goals can be achieved with a circular Gaussian (or Bessel) beam having ω₀=30 μm and I₀=10⁸ W/cm², which corresponds to a cw laser power of 1.4 KW. At an intersection angle of δ=5⁰, the focal coordinates are x_{f}=9.2 cm and z_{f}=0.8 cm (see FIG. 3).

The requisite power can be lowered by further reducing δ. A lower bound on δ can be set by requiring that the incidence angle be at least twice the divergence angle of the laser beam, which can be, for example, 0.6⁰ for ω₀=30 μm and λ=1.06 μm. At grazing incidence, x_{f} grows approximately linearly with δ, whereas z_{f} grows faster than linearly, and both focal distances vary inversely with intensity. Thus, for example, at δ=3⁰ and a power of 1 KW, x_{f}=10.0 cm and z_{f}=0.5 cm.

The existence of high-power, continuous wave, diode-pumped solid-state lasers allows the construction of a suitable KW-level radiation source for molecular lithography. For example, Stewen et al. [15] demonstrated multi-mode ˜1 KW output powers from a diode-pumped Yb:YAG laser, based upon the thin-disk principle to mitigate thermal management problems in the gain medium. A commercial laser encompassing the Yb:YAG thin-disk design and generating up to 100 W of output power in the fundamental TEM₀₀ spatial mode (M²<1.1) is now also available (see www.versadisk.com). Therefore, it is possible to construct the required KW-level TEM₀₀-mode cw laser using a standard master-oscillator power-amplifier (MOPA) design. There is, however, at least one more efficient and cost-effective alternative.

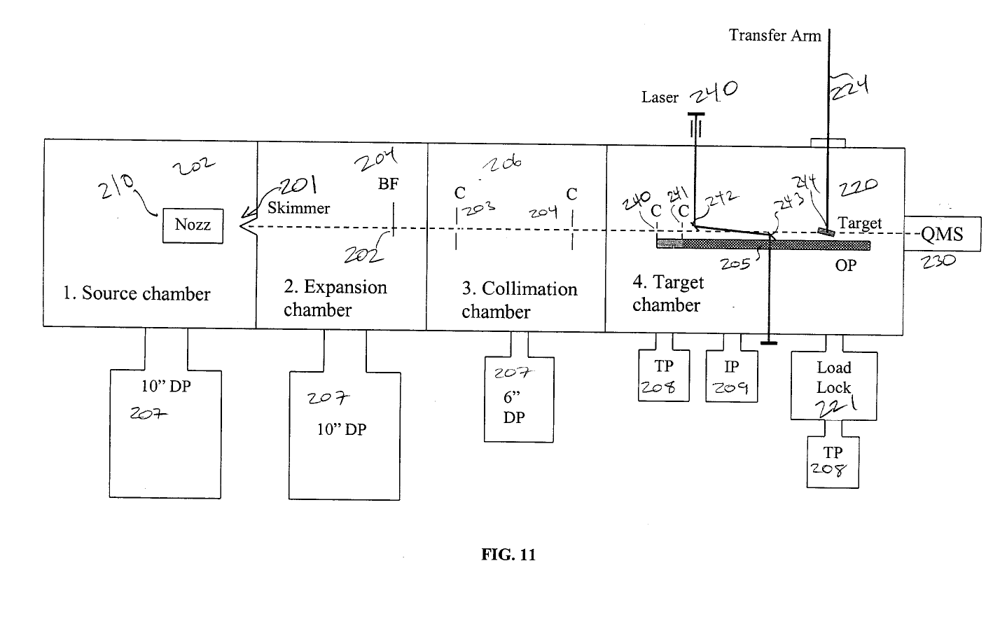

In an exemplary embodiment of the present invention, shown in FIG. 10, a diode pumped Ytterbium-doped YAG (Yb:YAG) laser 40 is utilized to provide radiation for the nanolithography molecular beam machine 100. The Yb:YAG laser provides an intense source of infrared laser radiation where as mentioned above intense means a beam with intensity in excess of approximately 2×10⁷ W/cm² when operated in continuous mode and in excess of approximately 2×10¹¹ W/Cm² when operated in pulsed mode. Because Yb:YAG lasers are generally characterized by small (e.g. approximately 10%) quantum defect where only a fraction of pump photon energy dissipates to heat, a Yb:YAG laser 40 may be suitable for the nanolithography molecular beam machine 100. A Yb:YAG laser 40 which makes optimum use of large (e.g. approximately 10%) Yb doping concentrations to ameliorate thermal management problems by using a thin (e.g. approximately 100-200 μm) gain medium with a large contact area (e.g. approximately 1 cm²) for heat removal is suitable for the nanolithography molecular beam machine 100. In any alternative embodiment, any continuous wave laser providing near-fundamental mode (TEM₀₀) radiation with irradiances of approximately 1-100 MW/cm² may be utilized. Such a continuous wave laser may need to provide laser powers of greater than 1 kW for an approximate 100 μm spot size.

Continuing with FIG. 10, a typical cw solid-state laser based on diode-pumped Yb:YAG or Nd:YAG employs a 5-10% transmissive output coupler 44 [16]. This means that the circulating intracavity radiation 46 is over one order of magnitude stronger than that coupled out 48 of a linear laser resonator. For example, a 100 W laser employing a 10% output coupler will have a total power of ˜2 KW at any point in the cavity (i.e., twice the ˜1 KW intracavity power propagating in each direction). Thus, by incorporating a suitable focusing section (with a 30 μm spot size) intersecting the molecular beam in the laser cavity [17], a relatively modest (nominally 100 W) laser can suffice for the lithography radiation source. For a well-designed Yb:YAG thin-disk laser resonator, less than 500 W of diode pump power is expected to be needed in this case, even if significant control over the transverse mode structure is required. This is to be contrasted with a 1 KW cw Yb:YAG MOPA design, which would require the same diode power for the oscillator plus a further 2-3 KW of pump power for a 30-50% efficient amplifier [13].

Precise focusing of KW-level intracavity cw laser radiation at grazing incidence to a ˜10 μm-diameter molecular beam posses several challenges. In particular, it is desirable to reduce laser beam-pointing instabilities to less than 10 nm at the intracavity focus to maintain the integrity of a high-quality sub-100 nm molecular focus. Accordingly, (i) the laser resonator should be operated at its most stable point (i.e. near the center of a cavity stability region), (ii) the resonator should be designed to minimize susceptibity to thermal effects, and (iii) the directionality of the intracavity laser radiation should be well controlled. To those of ordinary skill in the art, the first two criteria suggest the use of a properly configured diode-pumped thin-disk laser resonator, which is stable against thermal effects in the gain medium because thermal diffusion is predominantly parallel to the optical axis of the resonator. The third criterion will be discussed later.

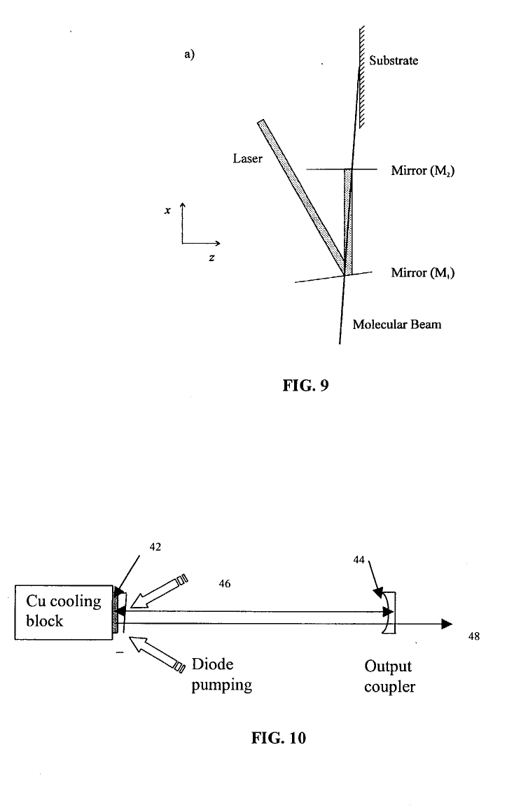

Referring to FIGS. 8, 9, & 10, the surface deposition chamber 20 allows for the intense laser beam to intersect the particle beam and focus it onto the substrate. For example, in continuous mode operation, the intense laser beam and the particle beam intersect at a grazing incidence, where grazing incidence means an intersection angle not greater than 5 degrees. The configuration of the two beams and the substrate is shown schematically in FIG. 9. A collimated laser beam is reflected by a dielectrically coated mirror (M₁) and retro-reflected by a second coated mirror (M₂). In an exemplary embodiment, the coated mirrors are specified by cw damage thresholds in excess of 10 MJ/cm² and are commercially available (e.g. Optima Research). In an alternate embodiment, an alternate design using prisms or grazing-incidence mirrors to position the laser beam is utilized. To prevent and minimize damage to the laser oscillator by the retroreflected beam, a birefringent prism, a polarizer, and a half wave plate may be inserted before M₁.

In the embodiment of FIG. 8, a transfer arm 24 is available to move the substrate between the deposition chamber 20 and the STM) chamber 30.

Because the nanometer-scale width of the deposited features may make the features vulnerable to degradation through exposure to the atmosphere, one alternative embodiment of the nanolithography molecular beam machine 100 is designed to operate in situ. As used herein, in situ means maintaining the target in its nascent environment. In an exemplary embodiment of the present invention, a suitable UHV STM system 28 manufactured by RHK Technology operates in situ. The microscope 28 may be housed in its own UHV chamber having all requisite pumps, gauges, valves etc. and may rest on a vibrationally isolated vacuum console. The STM system 28 may also include a load-lock separated from the STM chamber 30 by a gate-valve and a sample transfer rod with approximately 24″ of travel. The load lock may be pumped by a turbomolecular pump, which can also be used for rough pumping the STM chamber 30. Samples may be moved from a sample introduction rod to the STM chamber 30 with a wobble stick. Multiple samples and tips are stored next to the sample stage. The STM chamber 30 may include a port directly to connect to the deposition chamber 20. A gate valve of approximately 4.5″ will separate the STM chamber 30 from the deposition chambers 20 and may include a mechanism to only open when the molecular beam is off. A wobble stick may be used to transfer samples from the sample introduction rod to the STM chamber 30. Since the deposited features are sub-micron in width but with lengths on the order of approximately 1 mm, the STM 28 may be ideal to probe the size, shape, uniformity, and chemical purity of the features. The STM 28 may also be able to characterize in detail the shape of the deposited features and allow for observation of the structure at the interface between the deposited metal and the silicon substrate.

In an alternate embodiment, the nanolithography molecular beam apparatus may also include a PHI scanning Auger microprobe to observe other surface sensitive queries. A PHI scanning Auger microprobe may provide a two-dimensional elemental distribution map of a surface with a resolution of up to approximately 20 nm. Further, the PHI scanning Auger microprober may allow for observation of feature degradation due to atmospheric exposure and allow for assessment of the chemical purity of the nanowires.

FIG. 11 depicts a block diagram of an alternate exemplary embodiment of a nanolithography molecular beam machine 200 embodying the principles discussed above. The laser and molecular beams intersect at grazing incidence inside the laser cavity. The symbols denote the skimmer 201 (S), beam flag 202 (BF), first and second collimators 203, 204 (C), an optical platform 205 (OP), quadrupole mass spectrometer 206 (QMS), diffusion pumps 207 (DP), turbomolecular pumps 208 (TP), and ionization pump 209 (IP). As will be understood by those of ordinary skill in the art, different pumps that can be substituted for each other, provided that the appropriate conditions, also known to those of ordinary skill, are maintained in the chamber.

The nanolithography molecular beam machine 200 includes a highly-collimated, differentially-pumped molecular beam source 210 having an ultra-high vacuum (UHV) surface analysis chamber (“target chamber”) 220, including a load-lock 221 for inserting and removing samples, a transfer arm 224, a quadrupole mass spectrometer (QMS) 230 for monitoring the molecular beam, and an intense source of infrared laser field 240. As above, but not pictured here, a scanning tunneling microscope (STM) can be inserted between the target chamber and the load lock to enable in situ measurement of features deposited on the substrate.

As in the first embodiment, a source chamber 202, an expansion chamber 204, and a collimating chamber 206 prepare the molecular beam source 210 to deliver an intense, internally cold, and highly collimated stream of neutral molecules. The parameters for the molecular beam can be the same as in the first embodiment, as are the corresponding operation of the first three chambers 202, 204, 206.

The intracavity folding mirrors of the laser and the sample holder are mounted on an optical platform 205 (designated “OP” in FIG. 8) inside the target chamber. A pair of 10-20 μm slits 240, 241 (designated by “C” in FIG. 8) are also mounted on this platform 205 in order to define the initial width, Wᵢ, of the molecular beam before it intersects with the laser beam. The location of the mirrors 242, 243, sample holder 244, and collimating slits 240, 241 will be controlled remotely by piezoelectric transducers (not pictured) with 1 nm precision. In an exemplary embodiment, the target chamber can be exhausted by a 100 liter/s turbomolecular pump 208 and a 200 liter/s ion pump 209.

The third criterion, introduced above, can be challenging. If a Yb:YAG thin-disk laser is used, then the properties of Yb:YAG (saturation of the ground-state absorption in a multi-pass pumping scheme, etc. [13]) implies an ˜1 mm fundamental mode spot size (half-width at e⁻¹ of the field) at the gain medium. Accordingly, a focusing element with a focal length of about 10 cm can be used to generate the required 30 μm spot size at the intracavity focus. The requirement to reduce beam-pointing instabilities at the focus to less than 10 nm implies that fluctuations in the directionality of the intracavity radiation must be less than 0.1 μrad. It is possible to satisfy this rather demanding performance specification by inserting a capillary, rather than a simple aperture, in the cavity [13]. In addition to defining the optical axis of the laser resonator, a properly inserted intracavity capillary will force the spatial oscillation mode of the laser to match an HEₘₙ capillary mode. The cylindrically-symmetric fundamental HE₁₁ mode, which is represented by the J₀(r) Bessel function truncated at the first minimum (the capillary radius), produces a molecular beam focus that is very similar to a TEM₀₀ mode Gaussian spatial profile. The resulting configuration of the laser in the interaction region (i.e., the molecular lens at the intracavity focus) is depicted in FIGS. 11 & 12

Recalling the embodiment of FIGS. 8 and 9, the surface deposition chamber 20 allows for the intense laser beam to intersect the particle beam and focus it onto the substrate. For example, in continuous mode operation, the intense laser beam and the particle beam intersect at a grazing incidence, where grazing incidence is meant an intersection angle not greater than 5 degrees.

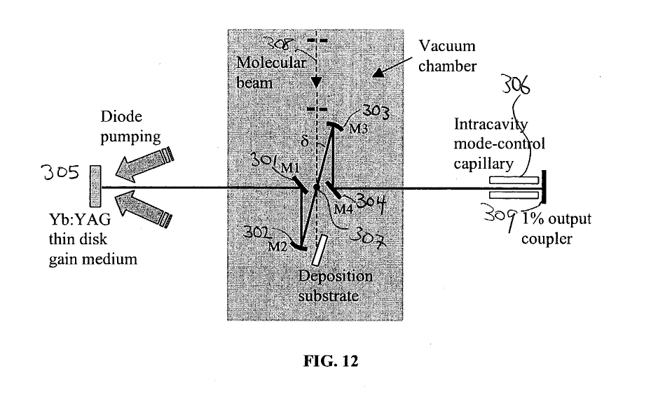

However, in the second embodiment 200, shown in FIG. 11, in order to overlap the 30 μm radiation lens with the 10 μm-diameter molecular beam, the position of the intracavity focal spot is controlled while maintaining alignment of the laser resonator. The laser resonator 300 depicted in FIG. 12 is presented with this in mind:

(a) The four mirrors (M1-M4) 301, 302, 303, 304 in the focusing section can be mounted on a single base (not shown) that can be translated using a so called piezo-electric (PZT) transducer, as is known in the art, along the axis of the cavity (gain medium 305 to output coupler 306) to position the intracavity focal spot in the vertical plane (out of the paper) containing the molecular beam.

(b) The distances between M1 301, M2 302, the focal spot, M3 303, and M4 304 can all be the focal length f of the focusing mirrors M2 302 and M3 303. Simultaneous control (using PZT actuators) of the vertical intracavity beam deflection from mirrors M1 301 and M4 304 can then allow the focal spot 307 to be moved in the vertical plane to intersect with the molecular beam 308 while maintaining laser oscillation.

With this arrangement, only the mirrors M1-M4 301, 302, 303, 304 will need to be placed inside the vacuum chamber, permitting desirable access to the rest of the laser optics; that is, the vacuum chamber will intersect the laser cavity. Brewster-angled windows, oriented to ensure vertically polarized radiation, can be used to couple the intracavity radiation into and out of the vacuum chamber.

Piezo-electric control over the position of the deposition substrate in the UHV chamber can also be used to accurately position the substrate surface at the molecular focus. In addition, coarse control (over several inches) of the position of the substrate can also be provided, because the radiation lens can have different focal lengths for different molecular (or atomic) species due to their differing polarizabilities. Of course, changing the cw laser power (e.g. through the diode laser pump power) can, to some extent, be used to control the position of the molecular focus. To this end a calibrated 1% output coupler 309 can be used to measure the cw intracavity laser power.

In the embodiment of FIG. 11, a transfer arm 224 and wobble stick (not shown) is available to move the substrate between the deposition chamber 220 and the load lock (and/or the STM) chamber 221. The molecular beam is detected by a quadrupole mass spectrometer 230 (QMS) mounted at the end of the target chamber. This detector will be used to assist in the alignment of the molecular beam, as described below.

To produce nm-scale features the apparatus can be isolated from all sources of vibration so as to allow positioning of key components with nm precision. To reduce the amount of vibration, all the vacuum chambers can be mounted on an optical table with actively controlled vibrational isolation. All mechanical pumps and the water-chilled laser diodes can be mechanically isolated from this table. To achieve stability and precision, the mirrors, apertures, and substrate can be positioned with piezoelectric transducers (PZT's). The molecular beam can be aligned by using PZT's first to position the collimators in the collimation chamber, and then by positioning the beam-defining apertures in the target chamber. A feedback signal from a laser interferometer coupled to the defining apertures can then be used to stabilize their position. The signal from the QMS can be used to determine when the beam passes through the collimators and apertures. Alignment of the laser can be achieved by using the PZT's to control the positions of mirrors M1 and M2 while monitoring the laser power. To align the molecular beam with respect to the laser, a PZT will be used to translate a platform on which all four mirrors are mounted. This last alignment step can be detected by a decrease in the QMS signal resulting from deflection of the molecules by the laser. Finally, the position of the substrate can by controlled in two dimensions by a pair of PZT's.

Nanolithography molecular beam machines (including, but not limited to embodiments 100, 200) of the present invention, with present technology can by configured to use a cw laser to create wires <50 nm wide and >100 μm long. Because the feature width scales inversely with the product of the polarizabilty and laser intensity, a further order-of-magnitude reduction in width, or increase in feature length, is feasible. This technique is very general, and may be used to deposit any atom or molecule on an arbitrary substrate, so long as the particles can be entrained in a molecular beam and have a sufficient sticking probability.

Further, a focused laser field can also align an anisotropic molecule. If the field turns off slowly compared with the rotational period of the molecule, the particle loses its alignment when the field is off. In contrast, with a rapid turn-off (achievable by those of ordinary skill in the art, but not disclosed herein) of the laser pulse a rotational wave packet is formed, which realigns periodically with a recurrence time τ_{rec}=(2Bc)⁻¹, where B is the rotational constant and c is the speed of light. By positioning a substrate so that the particles arrive at a multiple of τ_{rec}, it is possible to create structures of aligned particles. Moreover, even in the absence of a recurrence the molecules excited with short pulses possess greater-than-random alignment, which can be utilized to create ordered structures.

In prior art references, the employ of pulsed lasers has been required in order to achieve the high peak intensities required to deflect a neutral particle. Pulsed mode operation may be necessary to observe rotational recurrences. There are, however, at least two disadvantages associated with pulsed operation. First may be the low (˜10⁻⁴) duty cycle of the laser. Second, because the molecular beam pulse may be much longer than the laser pulse, it may be necessary to use two or more molecular lenses to deflect and then focus the molecular beam onto the surface, so that particles do not reach the surface when the laser is off. With an embodiment of the nanolithography molecular beam machine 100 of the present invention, it may be possible to operate the apparatus continuously by taking advantage of the fact that the molecular lens properties scale as R, which is proportional to v_{z}²/I. To slow the molecules, the velocity component normal to the field gradient may be reduced. This reduction may be achieved by intersecting the laser and molecular beams at a grazing angle. In another embodiment, a short pulse laser may be used to align the molecules and a cw laser may be used to focus them onto the substrate.

Because the focusing properties of a molecular lens scale as the ratio of the kinetic energy to the laser intensity, it is possible to reduce the requisite laser power by lowering the speed of the molecular beam. One way to reduce the speed is to seed the molecule of interest in a heavy carrier gas. Still further slowing is difficult to achieve by conventional means. A major finding in this disclosure, however, is that for molecular lithography it is sufficient to reduce only the component of the velocity transverse to the laser beam, which may be accomplished rather simply by intersecting the laser and molecular beams at grazing incidence. At incidence angles on the order of δ=5⁰, the requisite laser power is reduced to the point that presently available continuous-wave lasers could be used. A further benefit of using a grazing incidence is that the length of the deposited structure vary as 1/sin δ, enabling the production of nanowires >100 μm long.

The advantages of using cw rather than pulsed lasers for molecular lithography are the vastly increased duty cycle and the suppression of background molecules when the laser is off. An order of magnitude further reduction in laser power may be achieved by placing the interaction region of the laser, molecular beam, and target surface within the laser cavity. Using a capillary to guide the laser beam serves the dual purpose of improving the pointing stability of the beam and eliminating unwanted transverse modes of the laser. Using realistic physical parameters we estimate that is should be possible to produce 50 nm wide structures with atoms and isotropic molecules and 200 nm features with anisotropic molecules with a 100 W cw laser. Because the feature width scales inversely with laser power, a further order-of-magnitude reduction in feature width, or increase in feature length, is feasible.

Although the examples cited above use I₂ as a prototypical molecule, the apparatus and methods are completely general, however, and may be applied to any species that can be entrained in a molecular beam. With pulsed lasers there is not much advantage in using highly polarizable species because the ionization potential generally decreases as the polarizability increases, setting an upper bound on the intensity that may be used to deflect the molecules. The much lower intensity of a cw source, however, allows one to make full use of the enhanced polarizability of some species. Cs atoms, for example, require 6.7 lower intensity that 12 to reach the same focal distance (recalling that the focal distance scales as m/αI₀). Metal clusters with small m/α ratios may also be attractive candidates.

From the foregoing, it will be observed that numerous modifications and variations can be effectuated without departing from the true spirit and scope of the novel concepts of the present invention. It is to be understood that no limitation with respect to the specific embodiment illustrated is intended or should be inferred. The disclosure is intended to cover by the appended claims all such modifications as fall within the scope of the claims.

Each of the patents and articles cited herein is incorporated by reference. The use of the article “a” or “an” is intended to include one or more.

### REFERENCES

[1] T. Seideman, Phys. Rev. A 56, R17 (1997).

[2] T. Seideman, J. Chem. Phys. 106, 2881 (1997).

[3] T. Seideman, J. Chem. Phys. 107, 10420 (1997).

[4] Z.-C. Yan and T. Seideman, J. Chem. Phys. 111, 4113 (1999).

[5] T. Seideman, J. Chem. Phys. 111 4397 (1999).

[6] H. Stapelfeldt, H. Sakai H, E. Constant, and P. B. Corkum, Phys. Rev. Lett. 79, 2787 (1997).

[7] H. Sakai, A. Tarasevitch, J. Danilov, H. Stapelfeldt, R. W. Yip, C. Ellert, E. Constant, and P. B. Corkum, Phys. Rev. A 57, 2794 (1998).

[8] B. S. Zhao, H. S. Chung, K. Cho, S. H. Lee, S. Hwang, J. Yu, Y. H. Ahn, J. Y. Sohn, D. S. Kim, W. K. Kang, and D. S. Chung, Phys. Rev. Lett. 85, 2705 (2000).

[9] S. Chung, B. S. Zhao, S. H. Lee, S. G. Hwang, K. C. Cho, S. H. Shim, S. M. Lim, W. K. Kang, and D. S. Chung, J. Chem. Phys. 114, 8293 (2001).

[10] See, for example, K. S. Johnson, J. H. Thywissen, N.H. Dekker, K. K. Berggren, A. P. Chu, R. Younkin, and M. Prentiss, Science 280, 1583 (1998).

[11] A. Yariv, Quantum Electronics, 3^{rd} Edit. (Wiley, New York, 1989), ch. 6.

[12] S. DePaul, D. Pullman, B. Friedrich, J. Phys. Chem. 97, 2167 (1993).

[13] A. N. Chester and R. L. Abrams, Appl. Phys Lett. 21, 576 (1972); R. L. Abrams and A. N. Chester, Appl. Opt. 13, 2117 (1974); F. P. Roullard III and M. Bass, IEEE J. Quant. Electron. QE-13, 813 (1977).

[14] J. Schmeidmayer, M. S. Chapman, C. R. Ekstrom, T. D. Hammond, D. A. Kokorowski, A. Lenef, A. Rubenstein, E. T. Smith, and D. E. Pritchard, Atom Interferometry, P. A. Berman, ed., pp 2-83 (Acamdeic Press, San Diego, 1997).

[15] C. Stewen, K. Contag, M. Larionov, A. Giesen, and H. Hügel, IEEE J. Sel. Top. Quant. Electron. 6, 650 (2000).

[16] W. Koechner, Solid-State Laser Engineering, 5^{th} edition, Springer Series in the Optical Sciences (Springer-Verlag, New York, 1999).

[17] S. T. Lee, G. McConnell, A. Major, N. Langford, and A. I. Ferguson, paper CWF4, p. 335, technical digest of the Conference on Lasers and Electro-Optics (CLEO) 2001 (Optical Society of America, 2001).

What is claimed is:

1. A method for direct writing on a surface of a substrate with neutral molecules comprising:
delivering a collimated beam of neutral molecules having a first direction of travel;
delivering a laser light energy field having a second direction of travel; and
intersecting the laser light energy field with the collimated beam of neutral molecules at a grazing angle of incidence between the first direction of travel and the second direction of travel to control the formation of features comprising the neutral molecules on the surface of the substrate.

2. The method of claim 1, wherein the neutral molecule is selected from the group consisting of: metal atoms, metal clusters, semiconductor atoms, semiconductor clusters, dielectric atoms, and dielectric molecules.

3. The method of claim 1, wherein the laser energy field has a divergence in the second direction of travel, and the angle of incidence between the first direction of travel and the second direction of travel is at least about twice the divergence of the laser energy field.

4. The method of claim 1, wherein the laser light energy field has a polarization vector and upon intersection with the laser light energy field the spatial extent of the collimated beam of neutral molecules is reduced in the direction of the polarization vector of the laser light energy field.

5. The method of claim 1, wherein delivering the laser light energy field comprises using a circular laser focus.

6. A method of reducing the chromatic aberration in the method of claim 1, wherein delivering the collimated beam of neutral molecules further comprises reducing the rotational temperature of the neutral molecules by introducing the neutral molecules as a seed gas contained in carrier gas through a nozzle via a supersonic expansion in a reduced pressure environment.

7. The method of claim 1, wherein delivering the laser light energy field further comprises suppressing higher order modes of the laser light energy field.

8. The method of claim 1, wherein the beam of neutral molecules is delivered as a pulsed beam of neutral molecules, the laser light source is delivered as a pulsed laser light field, and the pulsing of the molecular beam and the laser light field are synchronized.

9. The method of claim 1, wherein the beam of neutral molecules is delivered as a substantially continuous beam of neutral molecules, the laser light energy field is delivered as a substantially continuous laser light field.

10. The method of claim 1 wherein the laser light energy field is an intense laser beam.

11. The method of claim 1, wherein the beam of neutral molecules and the laser light energy field intersect in a reduced pressure environment having a pressure of less than 2×10⁻¹⁰ Torr.

12. The method of claim 1, wherein the beam of neutral molecules has a flux of about 10¹⁷-10¹⁹, a rotational temperature of the molecules of less than about 1 K, and a divergence of approximately 10 to 100 microradians.

13. A method of producing nanostructures with controlled electrical and optical properties comprising:
providing a plurality of neutral molecules having anisotropic polarizabilities;
moving the plurality of neutral molecules in a direction of travel; and
applying a dipole force to the molecules at a grazing angle of incidence relative to the direction of travel to manipulate the molecules according to influence the molecules further travel according to the molecules' anisotropic polarizabilities.

14. An apparatus for direct writing on a surface of a substrate with neutral molecules, the apparatus comprising:
a vacuum chamber;
a molecular beam source configured to deliver a collimated beam of neutral molecules into the vacuum chamber;
a laser light source configurable to intersect a laser light energy field with the collimated beam of neutral molecules at a grazing angle of incidence in the vacuum chamber;
wherein the intense laser light can focus the collimated beam of neutral molecules onto the surface of the substrate such that molecules can form features on the surface of the substrate.

15. The apparatus of claim 14, wherein the molecular beam source produces a pulsed beam of neutral molecules, and the laser light source produces a pulsed laser light field and the pulsing of the molecular beam and the laser light field are synchronized to substantially intersect the two beams.

16. The apparatus of claim 14, wherein the molecular beam source produces a continuous beam of neutral molecules, and the laser light source produces a continuous wave laser light field.

17. The apparatus of claim 14, wherein the laser light source further comprises a capillary, configurable to pass the laser light energy field through the capillary before the laser light energy field intersects the beam of neutral molecules.

18. The apparatus of claim 17, wherein the radius of the capillary is selected to suppress higher order modes of the laser light energy field.

19. An apparatus for direct writing on a surface of a substrate with neutral molecules, the apparatus comprising:
a vacuum chamber;
a molecular beam source configured to deliver a substantially continuous collimated beam of neutral molecules into the vacuum chamber;
a laser light resonance cavity configurable to intersect a laser light energy field with the collimated beam of neutral molecules at a grazing angle of incidence in the vacuum chamber;
wherein the intense laser light can focus the collimated beam of neutral molecules onto the surface of the substrate such that molecules can form features on the surface of the substrate.

20. The apparatus of claim 19 wherein the laser light resonance cavity comprises at least one thin Yb:YAG gain medium with a large contact area.

21. The apparatus of claim 19 further comprising a focusing element in the laser resonance cavity.

22. The apparatus of claim 21, wherein the focusing element has a focal length of about 10 cm and generates an approximately 30 micrometer spot size at the intracavity focus.

23. The apparatus of claim 19, wherein the vacuum chamber further comprises Brewster-angled windows that oriented to assure vertically polarized radiation can be used to couple the intracavity radiation into and out of the vacuum chamber.

24. The apparatus of claim 19, further comprising a nozzle for introducing the neutral molecules as a seed gas contained in carrier gas via a supersonic expansion in a reduced pressure environment.
